(19) United States
(12) Patent Application Publication
(10) Pub. No.: US 2019/0254153 A1
(43) Pub. Date: Aug. 15, 2019

(54) COMPOSITE DEVICE FOR TREATMENT

(71) Applicant: ELECTRONICS AND TELECOMMUNICATIONS RESEARCH INSTITUTE, Daejeon (KR)

(72) Inventor: Yark Yeon KIM, Daejeon (KR)

(21) Appl. No.: 16/259,958

(22) Filed: Jan. 28, 2019

(30) Foreign Application Priority Data
Feb. 13, 2018 (KR) 10-2018-0018005
Oct. 23, 2018 (KR) 10-2018-0127066

(51) Int. Cl. H05H 1/40; H05H 1/36

(52) U.S. Cl. CPC H05H 1/40; H05H 2001/3415; H05H 1/36

(57) ABSTRACT

Provided is a composite device for treatment including a power electrode, a ground electrode provided on one end of the power electrode, a coil surrounding the other end of the power electrode, a high voltage power source electrically connected to the power electrode, and a low voltage power source electrically connected to the coil. The power electrode includes a soft magnetic body, and the low voltage power source provides an AC voltage to the coil.

### CROSS-REFERENCE TO RELATED APPLICATIONS

This U.S. non-provisional patent application claims priority under 35 U.S.C. § 119 of Korean Patent Application Nos. 10-2018-0018005, filed on Feb. 13, 2018, and 10-2018-0127066, filed on Oct. 23, 2018, the entire contents of which are hereby incorporated by reference.

### BACKGROUND

The present disclosure herein relates to a composite device for treatment.

In the case of treatment using atmospheric plasma, effective results on hemostasis, blood clotting, disinfection, and cell regeneration have been reported.

In the case of treatment using magnetic stimulation, results have been reported that cancer cells are killed by generating heat, and metabolism of fibroblasts and chondrocytes is promoted.

### SUMMARY

The present disclosure is to provide a composite device for treatment to simultaneously or individually treat the skin surface and the deep skin of the body.

An embodiment of the inventive concept provides a composite device for treatment including: a power electrode; a ground electrode provided on one end of the power electrode; a coil surrounding the other end of the power electrode; a high voltage power source electrically connected to the power electrode; and a low voltage power source electrically connected to the coil, wherein the power electrode includes a soft magnetic body, and the low voltage power source provides an AC voltage to the coil.

In an embodiment, the ground electrode may surround the one end of the power electrode.

In an embodiment, the composite device for treatment may further include a first insulation tube, a second insulation tube, and a third insulation tube, wherein the first insulation tube may cover the power electrode, the ground electrode may surround the first insulation tube, the second insulation tube may surround the ground electrode, the coil may surround the second insulation tube, and the third insulation tube may surround the coil.

In an embodiment, the ground electrode may include spirally wound wires, wires arranged laterally spaced apart, or wires arranged in a mesh structure.

In an embodiment, the ground electrode may cover an upper surface of the one end of the power electrode.

In an embodiment, the composite device for treatment may further include a first insulation tube, a second insulation tube, and a third insulation tube, wherein the first insulation tube may cover the power electrode, the ground electrode may surround the first insulation tube, the second insulation tube may surround the ground electrode, the coil may surround the second insulation tube, and the third insulation tube may surround the coil.

In an embodiment, the power electrode may include a plurality of rod-shaped electrodes, wherein the first insulation tube may include a plurality of openings in a lower surface.

In an embodiment, each of the rod-shaped electrodes and each of the plurality of openings may have a diameter, wherein the diameter of each of the rod-shaped electrodes may be greater than the diameter of each of the plurality of openings.

In an embodiment, the ground electrode may include a ring electrode and a frame electrode inside the ring, wherein the frame electrode may have a shape in which linear wires are spaced apart from each other, or a shape in which wires are in a mesh structure.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a cross-sectional view of a composite device for treatment according to an embodiment of the inventive concept;

FIG. 2 is a plan view showing an upper part of FIG. 1;

FIG. 3 is a plan view showing a lower part of FIG. 1;

FIG. 4 shows the degree of magnetization of a magnetic body when an external magnetic field is applied

FIGS. 5 to 7 show various shapes of a ground electrode;

FIG. 8 is a cross-sectional view of a composite device for treatment according to another embodiment of the inventive concept;

FIG. 9 is a cross-sectional view taken along a line I-I′ of FIG. 8;

FIG. 10 is an enlarged view of a portion aa of FIG. 8; and

FIGS. 11 and 12 are plan views showing the shape of a ground electrode.

### DETAILED DESCRIPTION

In order to fully understand the configuration and effects of the technical spirit of the inventive concept, preferred embodiments of the technical spirit of the inventive concept will be described with reference to the accompanying drawings. However, the technical spirit of the inventive concept is not limited to the embodiments set forth herein and may be implemented in various forms and various modifications may be applied thereto. Only, the technical spirit of the inventive concept is disclosed to the full through the description of the embodiments, and it is provided to those skilled in the art that the inventive concept belongs to inform the scope of the inventive concept completely. In the accompanying drawings, for convenience of explanation, the components are enlarged in size than the actual size, and the proportions of each component may be exaggerated or reduced.

Unless otherwise the terms used in embodiments of the inventive concept are defined differently, they may be interpreted as commonly known to those skilled in the art. Hereinafter, preferred embodiments of the technical spirit of the inventive concept are described with reference to the accompanying drawings so that the inventive concept is described in more detail.

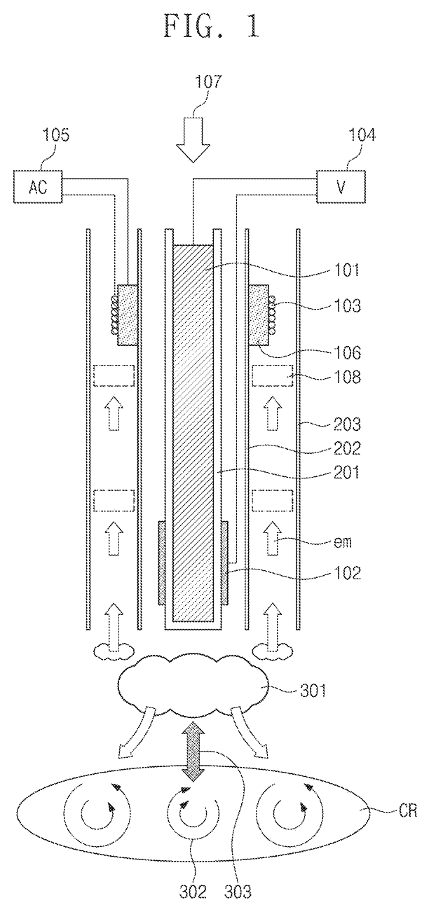

FIG. 1 is a cross-sectional view of a composite device for treatment according to an embodiment of the inventive concept.

A power electrode 101, a ground electrode 102 provided on one end of the power electrode 101, and a coil 103 surrounding the other end of the power electrode 101 may be provided.

The ground electrode 102 may specifically surround one end of the power electrode 101.

The power electrode 101 may be formed in a rod shape having a large ratio of the vertical length to the left-right diameter. The power electrode 101 may include a soft magnetic body. The soft magnetic body may include at least one of Mn—Zn, Ni—Zn, and Cu—Zn.

A bobbin 106 to which the coil 103 is directly wound may be provided. The coil 103 may have a shape in which a conductive wire directly winds the side surface of the bobbin 106. Preferably, the wire may be a copper wire. The bobbin 106 may be a non-magnetic body including an insulating material.

A high voltage power source 104 may be electrically connected to the power electrode 101 and the ground electrode 102. A low voltage power source 105 may be electrically connected to the coil 103 and the bobbin 106. The low voltage power source 105 may be an AC voltage.

A reaction gas 107 may be injected from the upper part of the coil 103. The reaction gas 107 may be moved toward the ground electrode 102. The reaction gas 107 may include at least one of helium, argon, air (oxygen, nitrogen), and the like. Since helium gas has a low discharge voltage, the reaction gas 107 may be preferably a helium gas.

A plasma plume 301 may be generated in the side surface portion of the ground electrode 102. The plasma plume 301 may be generated by electrically discharging the reaction gas 107.

The plasma plume 301 may be delivered to the lower end of the ground electrode 102 by the continuously injected reaction gas 107. A treatment portion CR to be treated may be located at the lower end of the ground electrode 102. The treatment portion CR treated by the plasma plume 301 may be, for example, a body surface such as a skin.

The composite device for treatment of the inventive concept may further include a pressure regulator (not shown), a flow rate regulator (not shown), and a blower (not shown). The delivery rate of the plasma plume 301 may be controlled by a pressure regulator (not shown) and a flow regulator (not shown). In addition, the circulation of the gas injected by the blower (not shown) and the exhaust gas (plasma plume and un-reacted gas) may be controlled.

An eddy current 302 may occur within the body or/and on the body surface, which is the treatment portion CR. The low voltage power source 105 may apply a voltage to the coil 103 to generate a current in the coil 103. As the current is generated in the coil 103, the power electrode 101 adjacent to the coil 103 may be magnetized. A magnetic field is generated around the magnetized power electrode 101, and a change in magnetic field 303 may continuously occur as an AC voltage is applied. The eddy current 302 may occur in the treatment portion CR by this change in magnetic field 303 (Faraday's law of induction). The eddy current 302 may increase the temperature of a specific portion of the human body (thermal effect). Such temperature increase may have effects such as cancer cell death. The eddy current 302 may occur not only in the deep portion of the skin but also on the skin surface.

The generation of the plasma plume 301 and the generation of the eddy current 302 may be performed simultaneously or separately. This may vary depending on whether the voltages of the high voltage power source 104 and the low voltage power source 105 are applied simultaneously or only partially.

A first insulation tube 201, a second insulation tube 202, and a third insulation tube 203 may be provided for the composite device for treatment.

The first insulation tube 201 may cover the power electrode 101. The ground electrode 102 may surround the first insulation tube 201. The first insulation tube 201 may serve to isolate the power electrode 101 and the ground electrode 102 from each other.

The second insulation tube 202 may surround the ground electrode 102. The bobbin 106 around which the coil 103 is wound may surround the second insulation tube 202. The second insulation tube 202 may be a tube into which the reaction gas 107 is injected and through which the plasma plume 301 is moved to the treatment portion CR.

The third insulation tube 203 may surround the coil 103. The third insulation tube 203 may be used for the re-introduction and discharge of the plasma plume 301. The re-introduced plasma plume 301 may be discharged to the outside through the discharge path em.

The composite device for treatment may further include a fixing part (not shown) for connecting the first insulation tube 201 and the third insulation tube 203. Through the fixing part (not shown), the first insulation tube 201 may be firmly fixed to the third insulation tube 203.

The composite device for treatment may further include connection means (not shown) for connecting the outer side surface of the first insulation tube 201 and the inner side surface of the second connection tube 202. Through the connection means (not shown), the first insulation tube 201 may be firmly fixed to the second insulation tube 202. The connection means (not shown) may have a ring structure and may include one or more openings that penetrate the ring. The reaction gas 107 may be delivered to the ground electrode 102 through the opening. The connection means (not shown) may be freely attachable and detachable.

One or more supports 108 may be provided on the side surface of the second insulation tube 202. The support 108 may have a ring structure and may include one or more openings (not shown) that penetrate the ring. The re-introduced plasma plume 301 passing through the discharge path em may be discharged to the outside through the opening.

The second insulation tube 202 may be moved up and down by sliding the third insulation tube 203 through the support 108. As the second insulation tube 202 is moved, the distance between the plasma plume 301 and the treatment portion CR and the distance between the power electrode 101 and the treatment portion CR may be adjusted.

After the distance is adjusted, the second insulation tube 202 may be fixed through fixing means (not shown) penetrating the third insulation tube 203 from the outside. The fixing means (not shown) may be connected to the support 108. The fixing means (not shown) may be a screw, for example.

That is, the movement and fixation of the second insulation tube 202 may be made freely according to the position of the treatment portion CR.

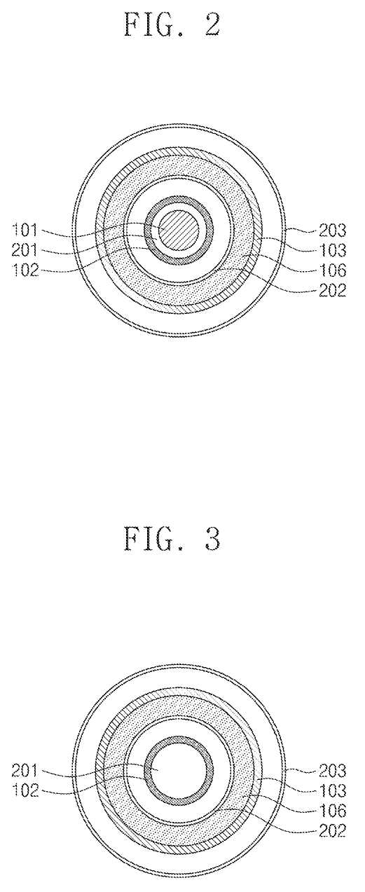

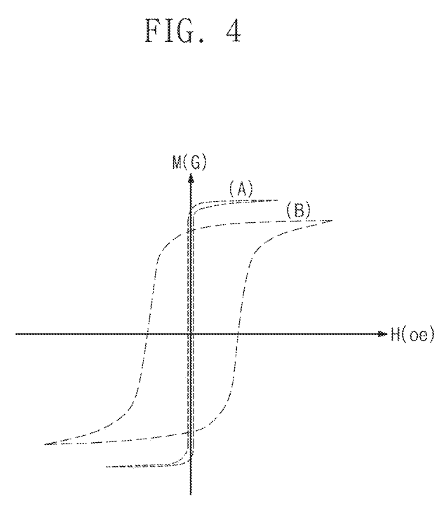

FIG. 2 is a plan view showing an upper surface of FIG. 1. FIG. 3 is a plan view showing a lower surface of FIG. 1. In a case of FIGS. 2 and 3, the support 108 is omitted.

When FIG. 3 is compared with FIG. 2, the upper surface of the first insulation tube 201 may have an open structure, and the lower surface of the first insulation tube 201 may have a structure in which a bottom surface is present and closed. In the case of the second insulation tube 202 and the third insulation tube 203, the upper and lower surfaces may be both opened.

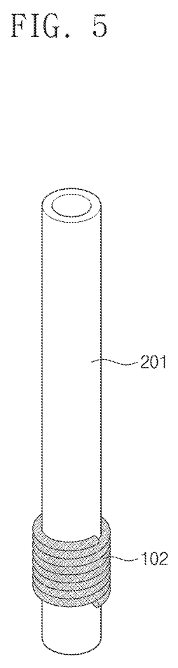

FIG. 4 shows the degree of magnetization of a magnetic body when an external magnetic field is applied. The horizontal axis represents the applied magnetic field H and the vertical axis represents the degree of magnetization M. (A) shows a degree of magnetization of the soft magnetic body constituting the power electrode 101 of the inventive concept. (B) shows a degree of magnetization of a hard magnetic body as a comparative example.

When looking at (A), a soft magnetic body usually does not have the function of a magnet, but may generate a very large magnetic field if a magnetic field is applied from the outside. If the current is applied in reverse, the direction of the magnetic field generated from the soft magnetic body may be easily changed.

On the contrary, when looking at (B), to magnetize the hard magnetic body, a large external magnetic field must be applied. However, a hard magnetic body may maintain its characteristics relatively once it is magnetized.

Referring again to FIG. 1, when a voltage is applied to the coil 103, the power electrode 101 made of a soft magnetic body may be magnetized. As AC voltage AC is applied, the direction of the magnetic field generated in the power electrode 101 may be rapidly changed. At this time, the change in magnetic field 303 in the treatment portion CR is maximized, so that the generation of the eddy current 302 may be advantageous. That is, by using a soft magnetic body for the power electrode 101, the generation of the eddy current 302 may be further advantageous.

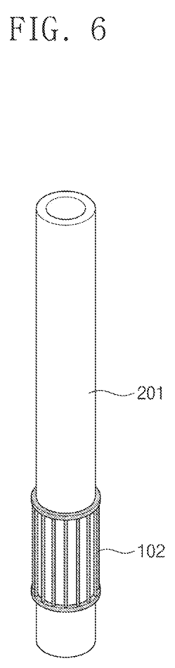

FIGS. 5 to 7 are views showing various shapes of a ground electrode. Referring to FIG. 5, the ground electrode 102 may include a spirally wound conductive wire. Referring to FIG. 6, the ground electrode 102 may include conductive wires arranged laterally spaced apart. Referring to FIG. 7, the ground electrode 102 may include conductive wires in the form of a mesh. To adjust the plasma discharge voltage or plasma density, various shapes may be applied to the ground electrode 102 instead of the pipe shape of the ground electrode 102 in FIG. 1.

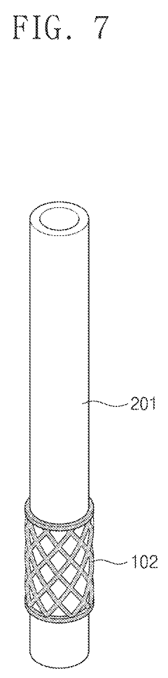

FIG. 8 is a cross-sectional view of a composite device for treatment according to another embodiment of the inventive concept. The same reference numerals are used for the elements described in the above embodiments of the inventive concept, and a detailed description thereof will be omitted.

The composite device for treatment according to another embodiment of the inventive concept, which is described with reference to FIG. 8, differs from the composite device for treatment according to the embodiment of the inventive concept in that it has a structure of another power electrode 101, a structure of another ground electrode 102, and a structure of another first insulation tube 201.

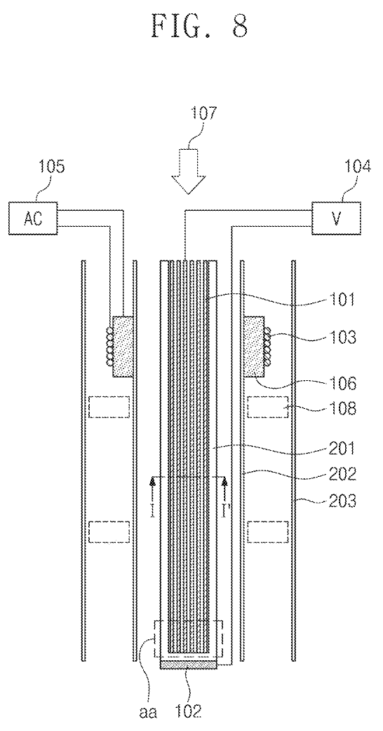

FIG. 9 is a cross-sectional view taken along a line I-I′ of FIG. 8. Referring to FIGS. 8 and 9, the power electrode 101 may be composed of several rod-shaped electrodes.

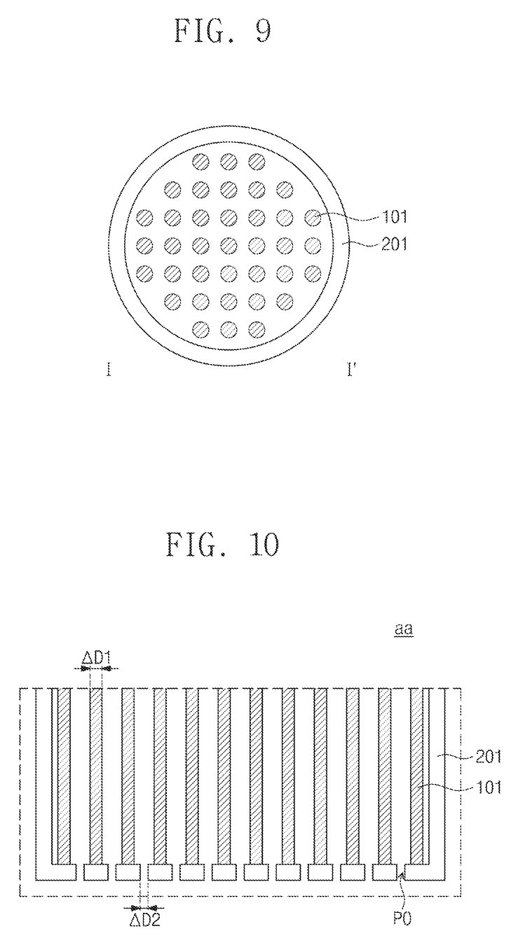

FIG. 10 is an enlarged view of a portion aa of FIG. 8.

Referring to FIGS. 8 and 10, the first insulation tube 201 may include a plurality of openings PO on a lower surface thereof. Each of the rod-shaped electrodes may have a diameter ΔD1, and each of the plurality of openings PO may have a diameter ΔD2. The diameter ΔD1 of each of the rod-shaped electrodes may be larger than the diameter ΔD2 of each of the plurality of openings PO. Accordingly, the rod-shaped electrodes may not be released to the outside of the first insulation tube 201 through the openings PO.

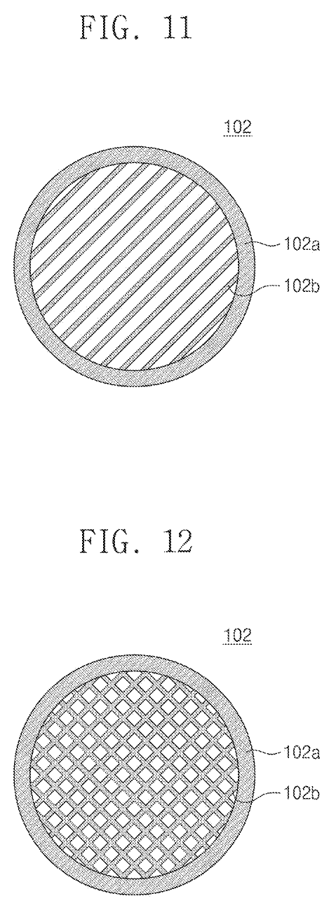

FIGS. 11 and 12 are plan views showing the shape of the ground electrode 102 of FIG. 9. Referring again to FIG. 9, the ground electrode 102 may cover the upper surface of one end of the power electrode 101.

Referring to FIGS. 11 and 12, the ground electrode 102 may include a ring electrode 102a and a frame electrode 102b inside the ring. The frame electrode 102b may be physically connected to the ring electrode 102a. The frame electrode 102b may include a shape in which linear wires are arranged apart from each other, as shown in FIG. 11, or a shape in which wires are formed in a mesh structure, as shown in FIG. 12.

Referring again to FIGS. 8, 9 and 10, the reaction gas 107 passes between the rod electrodes and passes through the first insulation tube 201 to be discharged at the ground electrode 102 so as to generate a plasma plume. The plasma plume may then reach the treatment portion.

This may be because the rod-shaped electrodes do not fill the inside of the first insulation tube 201, the first insulation tube 201 includes a plurality of openings PO, and the ground electrode 102 includes the frame electrode 102b which does not fill the inside.

The composite device for treatment of the inventive concept may increase the efficiency of a wound treatment of skin surface such as skin ulcers, burns, etc. through a plasma plume. In addition, through eddy current generation, a thermal treatment for increasing a temperature of a skin surface and a specific deep portion may be performed together.

Treatment on a skin surface and a skin deep portion of a body may be done simultaneously or separately.

Although the exemplary embodiments of the inventive concept have been described, it is understood that the inventive concept should not be limited to these exemplary embodiments but various changes and modifications may be made by one ordinary skilled in the art within the spirit and scope of the inventive concept as hereinafter claimed.

What is claimed is:

1. A composite device for treatment comprising:
a power electrode;
a ground electrode provided on one end of the power electrode;
a coil surrounding the other end of the power electrode;
a high voltage power source electrically connected to the power electrode; and
a low voltage power source electrically connected to the coil,
wherein the power electrode comprises a soft magnetic body, and the low voltage power source provides an AC voltage to the coil.

2. The composite device for treatment of claim 1, wherein the ground electrode surrounds the one end of the power electrode.

3. The composite device for treatment of claim 2, further comprising a first insulation tube, a second insulation tube, and a third insulation tube,
wherein the first insulation tube covers the power electrode,
the ground electrode surrounds the first insulation tube,
the second insulation tube surrounds the ground electrode,
the coil surrounds the second insulation tube, and
the third insulation tube surrounds the coil.

4. The composite device for treatment of claim 2, wherein the ground electrode comprises spirally wound wires, wires arranged laterally spaced apart, or wires arranged in a mesh structure.

5. The composite device for treatment of claim 1, wherein the ground electrode covers an upper surface of the one end of the power electrode.

6. The composite device for treatment of claim 5, further comprising a first insulation tube, a second insulation tube, and a third insulation tube,
wherein the first insulation tube covers the power electrode,
the ground electrode surrounds the first insulation tube,
the second insulation tube surrounds the ground electrode,
the coil surrounds the second insulation tube, and
the third insulation tube surrounds the coil.

7. The composite device for treatment of claim 6, wherein the power electrode comprises a plurality of rod-shaped electrodes,
wherein the first insulation tube comprises a plurality of openings in a lower surface.

8. The composite device for treatment of claim 7, wherein each of the rod-shaped electrodes and each of the plurality of openings have a diameter,
wherein the diameter of each of the rod-shaped electrodes is greater than the diameter of each of the plurality of openings.

9. The composite device for treatment of claim 5, wherein the ground electrode comprises a ring electrode and a frame electrode inside the ring,
wherein the frame electrode has a shape in which linear wires are spaced apart from each other, or a shape in which wires are in a mesh structure.
